(19) United States
(12) Patent Application Publication
(10) Pub. No.: US 2017/0262237 A1
(43) Pub. Date: Sep. 14, 2017

(54) IMAGE FORMING SYSTEM, IMAGE FORMING APPARATUS, METHOD FOR CONTROLLING IMAGE FORMING APPARATUS, AND NON-TRANSITORY COMPUTER READABLE MEDIUM STORING IMAGE FORMING PROGRAM

(71) Applicant: FUJI XEROX CO., LTD., Tokyo (JP)

(72) Inventor: Jo SUDA, Yokohama-shi (JP)

(73) Assignee: FUJI XEROX CO., LTD., Tokyo (JP)

(21) Appl. No.: 15/238,479

(22) Filed: Aug. 16, 2016

(30) Foreign Application Priority Data
Mar. 9, 2016 (JP) 2016-045435

(51) Int. Cl. G06F 3/12; H04N 1/00; H04N 1/21

(52) U.S. Cl. CPC G06F 3/1247; G06F 3/1206; G06F 3/1211; H04N 1/2104; H04N 1/00411; H04N 2201/0094

(57) ABSTRACT

An image forming system includes an information processing apparatus and an image forming apparatus. The information processing apparatus includes: an acquiring unit that acquires a document: a conversion unit that converts the document into an image capable of being output by the image forming apparatus; and a transmitting unit that transmits the image of the document obtained by the conversion to the image forming apparatus corresponding to the document. The image forming apparatus includes: a controller that receives the image and performs control to store the image in a storage device provided in the image forming apparatus; a presentation unit that presents a menu for outputting the image stored in the storage device in a case where a failure occurs in a communication line; and an output unit that outputs the image stored in the storage device in accordance with operation of an operator.

### CROSS-REFERENCE TO RELATED APPLICATIONS

This application is based on and claims priority under 35 USC 119 from Japanese Patent Application No. 2016-045435 filed on Mar. 9, 2016.

### BACKGROUND

### Technical Field

The present invention relates to an image forming system, an image forming apparatus, a method for controlling an image forming apparatus, and a non-transitory computer readable medium storing an image forming program.

### SUMMARY

According to an aspect of the invention, there is provided an image forming system comprising: an information processing apparatus; and an image forming apparatus, wherein the information processing apparatus comprising: an acquiring unit that acquires a document; a conversion unit that converts the document into an image capable of being output by the image forming apparatus; and a transmitting unit that transmits the image of the document obtained by the conversion to the image forming apparatus corresponding to the document, and wherein the image forming apparatus comprising: a controller that receives the image and performs control to store the image in a storage device provided in the image forming apparatus; a presentation unit that presents a menu for outputting the image stored in the storage device in a case where a failure occurs in a communication line; and an output unit that outputs the image stored in the storage device in accordance with operation of an operator.

### BRIEF DESCRIPTION OF THE DRAWINGS

Exemplary embodiments of the present invention will be described in detail based on the following figures, wherein:

FIG. 1 is a diagram showing a schematic module configuration regarding a configuration example of this exemplary embodiment:

FIG. 2 is a diagram showing an example of a system configuration using this exemplary embodiment;

FIG. 3 is a diagram showing an example of a system configuration using this exemplary embodiment;

FIG. 4 is a flow chart showing an example of a process according to this exemplary embodiment;

FIG. 5 is a diagram showing an example of presentation of a warning screen according to this exemplary embodiment;

FIG. 6 is a diagram showing an example of presentation of a confirmation screen according to this exemplary embodiment;

FIG. 7 is a diagram showing an example of presentation of a confirmation screen according to this exemplary embodiment;

FIG. 8 is a flow chart showing an example of a process according to this exemplary embodiment;

FIG. 9 is a diagram showing an example of a data structure of an image forming apparatus definition table;

FIG. 10 is a diagram showing an example of a data structure of an image forming apparatus definition table;

FIG. 11 is a diagram showing an example of a system configuration using this exemplary embodiment;

FIG. 12 is a flow chart showing an example of a process according to this exemplary embodiment;

FIG. 13 is a diagram showing an example of a data structure of an acquisition destination document table;

FIG. 14 is a diagram showing an example of a process according to this exemplary embodiment;

FIG. 15 is a diagram showing an example of a data structure of a re-printing necessity table;

FIG. 16 is a flow chart showing an example of a process according to this exemplary embodiment;

FIG. 17 is a flow chart showing an example of a process according to this exemplary embodiment; and

FIG. 18 is a block diagram showing an example of a hardware configuration of a computer that implements this exemplary embodiment.

### DETAILED DESCRIPTION

Hereinafter, an example of a preferable exemplary embodiment when implementing the invention will be described with reference to the accompanying drawings.

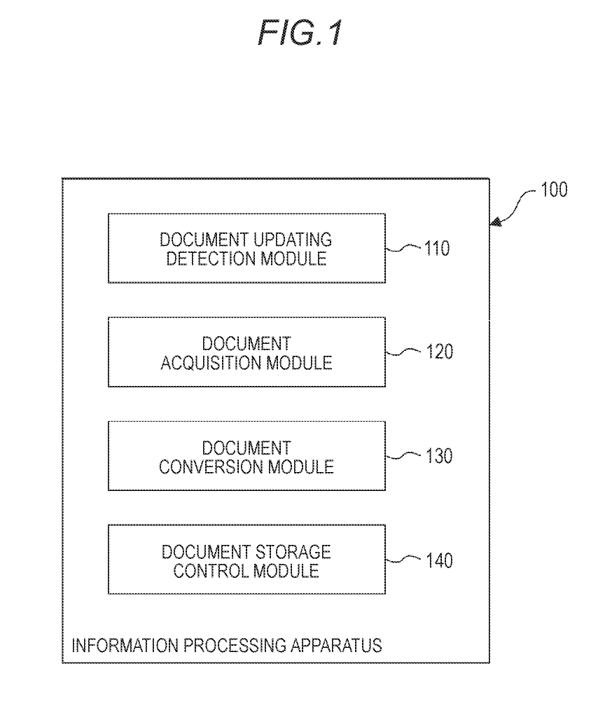

FIG. 1 is a diagram showing a schematic module configuration regarding a configuration example of this exemplary embodiment.

Meanwhile, the term “module” generally refers to a logically separable component such as software (computer program) or hardware. Therefore, each module in this exemplary embodiment not only refers to a module in a computer program, but also to a module in a hardware configuration. Accordingly, this exemplary embodiment is directed to a description of a computer program for causing a computer to function as each module (a program for causing the computer to execute each procedure, a program for causing the computer to function as each unit, and a program for causing the computer to achieve each function), as well as to a description of a system and a method. Although the expressions “store data”, “make a device store data” and expressions equivalent to these expressions are used for the sake of convenience, these expressions have a meaning of making a storage device store data or performing control to make the storage device store data in a case where the exemplary embodiment corresponds to a computer program. As an alternative to giving each module a single function, each module may be configured by a single program or multiple modules may be configured by a single program in actual implementation, or each module may be configured by multiple programs. Furthermore, multiple modules may be executed by a single computer, or a single module may be executed by multiple computers in a dispersed or parallel environment. As a further alternative, a single module may include another module. The term “connection” used hereinafter refers not only to a physical connection, but also to a logical connection (exchanging of data, sending of a command, or a reference relationship between data). The term “predetermined” refers to a state in which certain information is set before intended processing is to be performed, and includes not only a time point prior to commencement of processing according to this exemplary embodiment, but also a time point prior to the intended processing even when the processing according to this exemplary embodiment has already commenced, depending on the condition or the state at that time or depending on the condition or the state until that time. In a case where there are plural “predetermined values”, the predetermined values may be different from each another, and two or more predetermined values (naturally, all of the values are also included) may be the same as each other. A description having a meaning of “in a case of A, B is performed” is used as a meaning that it is determined whether condition A is satisfied, and that if the condition A is satisfied, B is performed. This description is not applicable if the determination as to whether the condition A is satisfied or not is unnecessary.

In addition, the terms “system” and “apparatus” include a case where plural computers, hardware units, or apparatuses are connected to each other via a communication unit, such as a network (including one-to-one communication connections), and also include a case where a single computer, a single hardware unit, or a single apparatus is used. These terms “apparatus” and “system” are used as terms with an equivalent meaning. It is needless to say that the term “system” does not include the meaning of a social “mechanism” (social system), which is a kind of a man-made agreement or arrangement.

In addition, in a case where processing is to be performed by each module or plural kinds of processing are to be performed within a module, target information is read from the storage device for each processing, and the processed result is written into the storage device upon completion of the processing. Therefore, descriptions regarding the reading of information from the storage device before the processing and writing of information into the storage device after the processing may be omitted. Examples of the storage device in this case may include a hard disk, a random access memory (RAM), an external storage medium, a storage device via a communication line, and a register within a central processing unit (CPU).

An information processing apparatus 100 according to this exemplary embodiment makes an image forming apparatus store an image, and includes a document updating detection module 110, a document acquisition module 120, a document conversion module 130, and a document storage control module 140 as shown in the example of FIG. 1. Meanwhile, the information processing apparatus 100 may be built into an intermediate server 200 as described later, or may be built into an image forming apparatus 220. Examples of an image forming apparatus include a copy machine, a facsimile, a printer, a multifunction machine (an image processing apparatus having two or more functions among functions of a scanner, a printer, a copy machine, a facsimile, and the like), and the like.

In a case where a disaster occurs, a failure also often occurs in a communication line. In such a case, the following problems occur. (1) In a case where a disaster occurs when any preparation is not made in a normal case, it is not possible to know what is a document necessary at that time. (2) Even when any preparation is made, it is not clear that the current document is the newest edition. (3) In a case where a document is present in an external device, the document cannot be acquired through a communication line. In other words, printing cannot be performed.

Meanwhile, generally, it is often assumed that a communication line operates normally in a business continuity plan (BCP) action during the occurrence of a disaster in a company.

The information processing apparatus 100 operates in a case where a communication line operates normally (generally, in a normal case).

The document updating detection module 110 detects the updating of a document which is acquired in the past. For example, the document updating detection module detects that a document stored in a predetermined storage location (a document management server, a path, a folder, a uniform resource locator (URL), or the like) has been updated.

The document acquisition module 120 acquires a document. In a case where a document acquired in the past becomes new (in a case where the updating of a document is detected by the document updating detection module 110), the document acquisition module 120 acquires the new document.

The document conversion module 130 converts a document acquired by the document acquisition module 120 into an image that can be output by an image forming apparatus. For example, the document is converted into a format of JPEG, TIFF, or the like. The reason for the conversion performed immediately before printing is performed by the image forming apparatus is because a time is required for printing in an emergency. In addition, since it is difficult to secure a power supply in an emergency, power consumption is also suppressed.

The document storage control module 140 performs control to store an image in a storage device of the image forming apparatus.

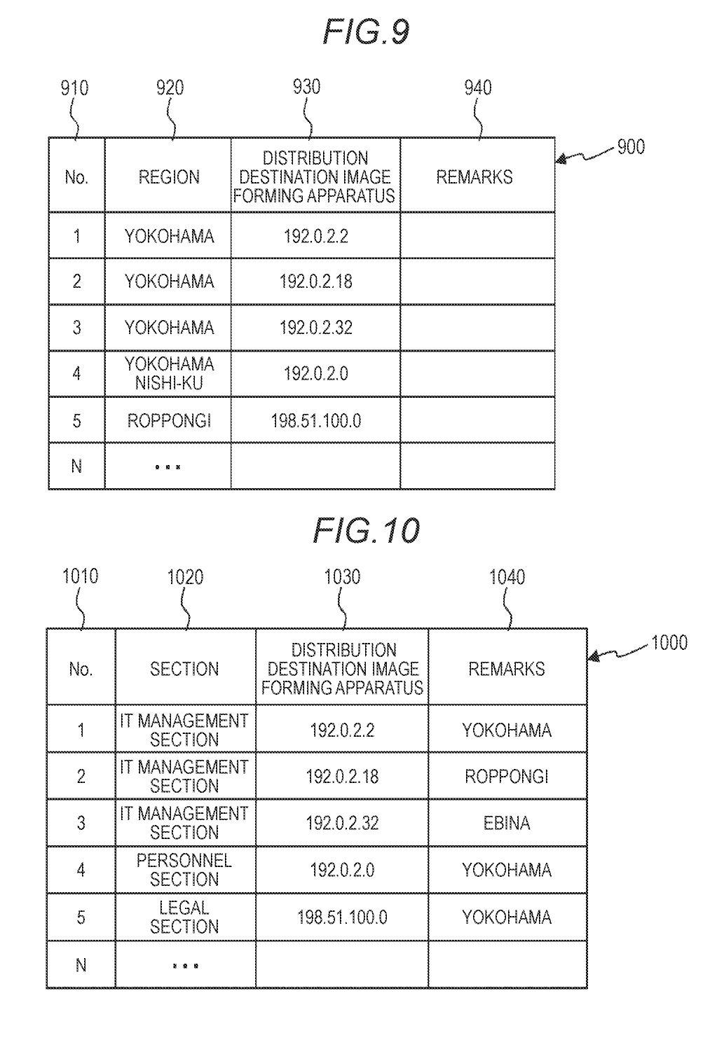

Specifically, in a case where the information processing apparatus 100 is built into the intermediate server 200 to be described later, the document storage control module 140 transmits an image of a document which is converted by the document conversion module 130 to an image forming apparatus corresponding to the document. The wording “image forming apparatus corresponding to a document” as used herein refers to an image forming apparatus within a limited region, for example, in a case where the document has regional characteristics. Examples of a document having regional characteristics include a homecoming map, a hazard map, and the like. An image of the document is required to be transmitted to an image forming apparatus which is installed in a region shown by the document in order to correspond to this. In addition, the invention is not limited to a region, and a section or the like may be used. This is because, for example, a document also varies in a case where correspondence in an emergency in the section varies. In order to realize the “image forming apparatus corresponding to a document”, for example, a table in which a document and an image forming apparatus are associated with each other (an image forming apparatus definition table 900 shown in an example of FIG. 9, an image forming apparatus definition table 1000 shown in an example of FIG. 10, or the like) may be prepared.

In addition, in a case where the information processing apparatus 100 is built into the image forming apparatus 220 to be described later, the document storage control module 140 performs control to store an image of a document converted by the document conversion module 130 in a storage device of the image forming apparatus 220.

In addition, in a case where a new document is acquired by the document acquisition module 120, the document storage control module 140 replaces an image of an old document to an image of a new document.

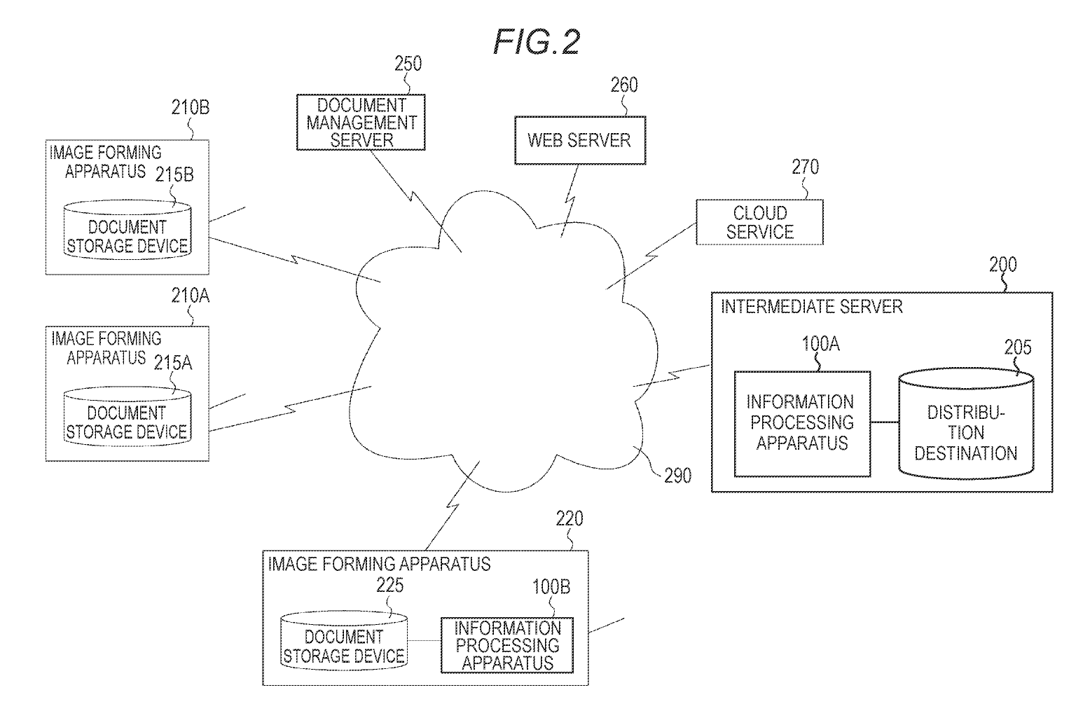

FIG. 2 is a diagram showing an example of a system configuration using this exemplary embodiment.

The intermediate server 200, an image forming apparatus 210A, an image forming apparatus 210B, the image forming apparatus 220, a document management server 250, a WEB server 260, and a cloud service 270 are connected to each other through a communication line 290. The communication line 290 may be a wireless or wired line, may be a combination thereof, or may be, for example, the Internet as communication infrastructure, an intranet, or the like. In addition, a function of the intermediate server 200 may be realized as a cloud service.

The intermediate server 200 includes an information processing apparatus 100A and a distribution destination data storage module 205. The information processing apparatus 100A and the distribution destination data storage module 205 are connected to each other. In a normal case, the intermediate server 200 acquires a document from the document management server 250, the WEB server 260, the cloud service 270, or the like. In addition, the document is converted into an image that can be output by the image forming apparatus 210, and is transmitted to the image forming apparatus 210.

The image forming apparatus 210A includes a document storage device 215A. The image forming apparatus 210B includes a document storage device 215B.

In a normal case, the image forming apparatus 210 receives an image from the intermediate server 200, and performs control to store the image in a document storage device 215 within the image forming apparatus 210.

The image forming apparatus 210 presents a menu for outputting an image stored in the document storage device 215 in a case where a failure occurs in the communication line 290.

In addition, the image forming apparatus 210 outputs (prints out) an image stored in the document storage device 215 in accordance with an operator's operation.

In addition, the image forming apparatus 220 includes an information processing apparatus 100B and a document storage device 225. The information processing apparatus 100B and the document storage device 225 are connected to each other.

In a normal case, the information processing apparatus 100B acquires a document from the document management server 250, the WEB server 260, the cloud service 270, or the like. Next, the acquired document is converted into an image that can be output by the image forming apparatus 220. In addition, the converted image is controlled to be stored in the document storage device 225 within the image forming apparatus 220.

The image forming apparatus 220 presents a menu for outputting an image stored in the document storage device 225 in a case where a failure occurs in the communication line 290.

In addition, the image forming apparatus 220 outputs an image stored in the document storage device 225 in accordance with an operator's operation.

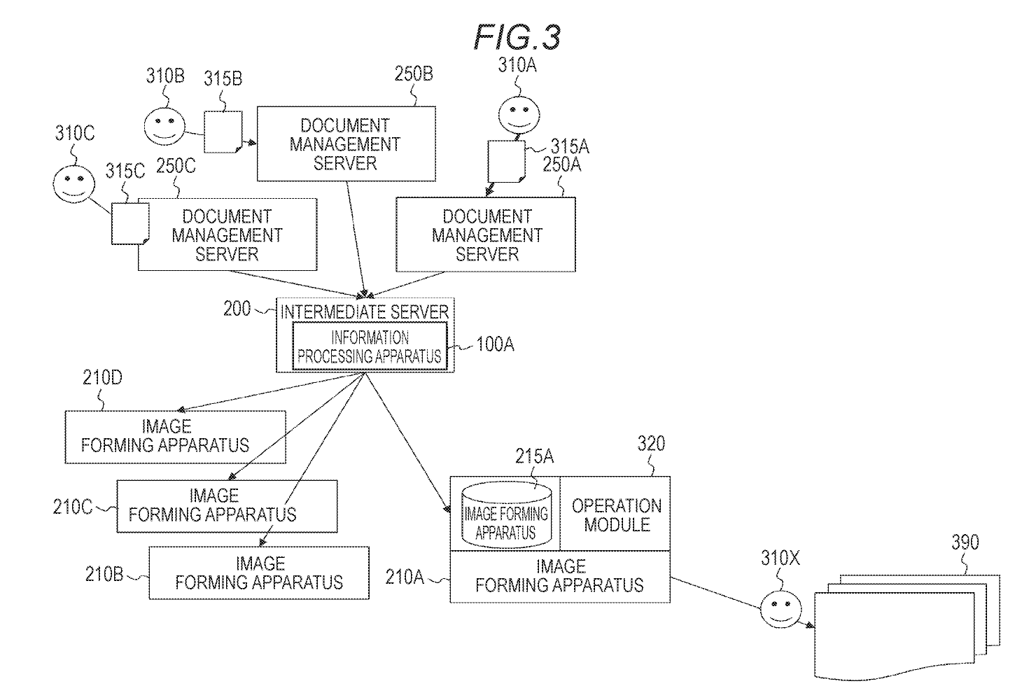

FIG. 3 is a diagram showing an example of a system configuration using this exemplary embodiment. An example of a process in a case where the information processing apparatus 100A is built into the intermediate server 200 is shown.

As described above, the document management server 250, the intermediate server 200, and the image forming apparatus 210 are communicably connected to each other through the communication line 290.

An electronic document 315 is stored in the document management server 250 in accordance with the operation of a user 310. The document management server 250 has a function of scanning the operation of a document with respect to a predetermined storage location. In addition, the document management server 250 has a function of transmitting the scanned document to the intermediate server 200.

A more specific description will be given below.

When the user 310 who is a file manager registers a document in a specific directory and updates the document, the document management server has a function of associating the registered and updated file with the intermediate server 200. In addition, the document management server issues a warning indicting distribution. The document management server has a “region” attribute and a “distribution flag for each region” attribute as attributes during distribution.

The intermediate server 200 has a function of selecting a target for distribution (image forming apparatus 210) which conforms to predetermined conditions. The intermediate server 200 has a function of distributing a document to the image forming apparatus 210. In addition, the intermediate server 200 includes a distribution region database. The distribution region database holds a list (for example, a list having contents of an IP address of the image forming apparatus 210 and the like) of the image forming apparatus 210 corresponding each distribution region. It is possible to distribute a document applied to a region in which the image forming apparatus 210 is installed.

A more specific description will be given below.

In a case where a “distribution flag for each region” attribute of a distribution file is turned on (ON), the image forming apparatus 210 conforming to the “region” is acquired, and distribution to the target image forming apparatus 210 is performed. The intermediate server 200 may be positioned in any place.

The image forming apparatus 210 includes the document storage device 215 and an operation module 320. The image forming apparatus 210 includes a mechanism capable of storing a document distributed from the intermediate server 200 in the document storage device 215. The operation module 320 of the image forming apparatus 210 has a function of presenting a dedicated menu for an emergency. A user 310X operates the menu to thereby acquire a printing document 390.

In addition, the image forming apparatus 210 may include a storage battery. For example, the image forming apparatus includes a lithium ion storage system. The image forming apparatus can print a document for coping with a disaster during the occurrence of the disaster. In addition, printing can be performed even in a case of a power failure as long as the image forming apparatus 210 is present. For example, a necessary document such as a notice, safety confirmation, a hazard map, or a wide area shelter can be printed even after a disaster.

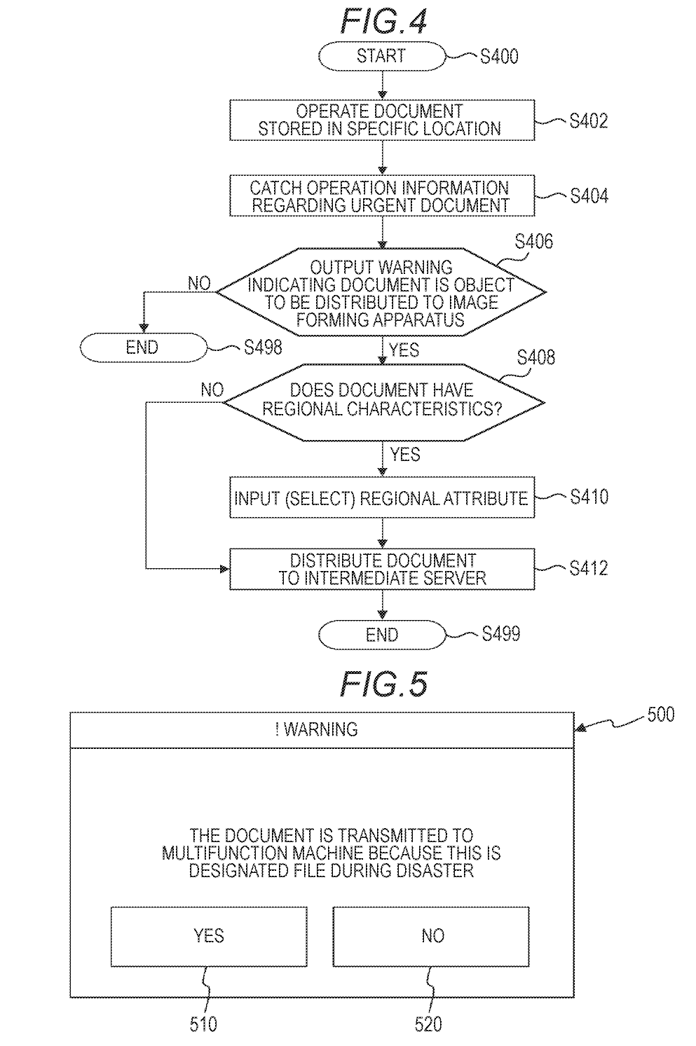

FIG. 4 is a flow chart showing an example of a process according to this exemplary embodiment (document management server 250 and the like).

In step S402, a document stored in a predetermined storage location is operated by a user. The operation may be an operation for a document which is accompanied by updating.

In step S404, operation information regarding an urgent document is caught. For example, updating being performed on a document stored in a predetermined storage location is detected.

In step S406, a warning indicating the document is an object to be distributed to an image forming apparatus is output, and it is determined whether to perform distribution in accordance with a user's operation.

In a case where the distribution is performed, the process proceeds to step S408, and otherwise the process is terminated (step S498). A warning indicating that distribution to an image forming apparatus is performed because of a document being stored in a predetermined storage location is output. For example, a warning screen 500 shown in FIG. 5 is displayed. FIG. 5 is a diagram showing an example of presentation of the warning screen 500 according to this exemplary embodiment. For example, a message “The document is transmitted to a multifunction machine because this is a designated file during a disaster” is displayed on the warning screen 500, and a “YES” button 510 and a “NO” button 520 are displayed.

In step S408, it is determined whether a document has regional characteristics in accordance with a user's operation.

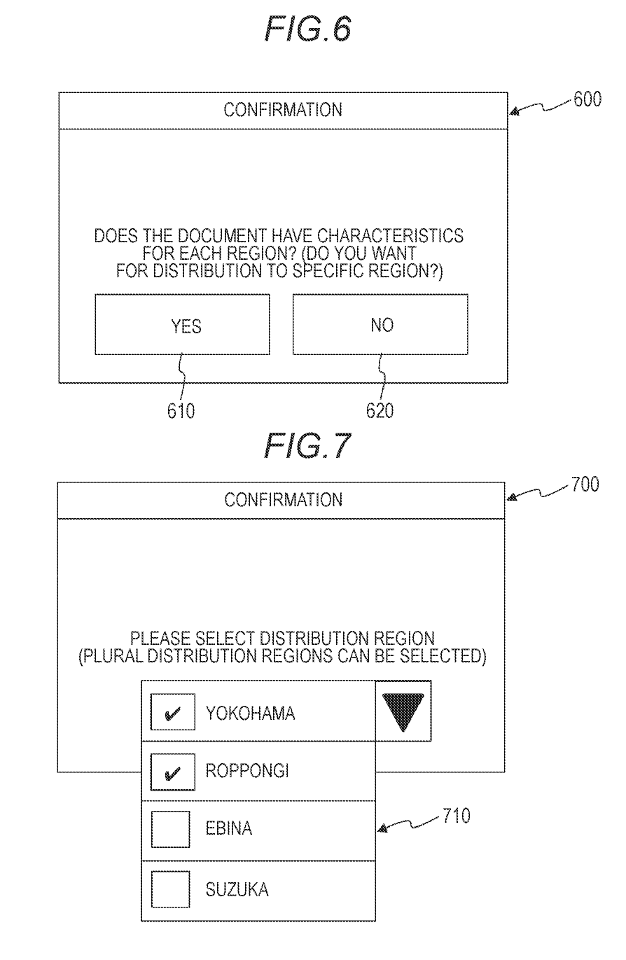

In a case where the document has regional characteristics, the process proceeds to step S410, and otherwise the process proceeds to step S412. For example, a confirmation screen 600 shown in FIG. 6 is displayed. FIG. 6 is a diagram showing an example of presentation of a confirmation screen 600 according to this exemplary embodiment. For example, a message “Does the document have characteristics for each region? (Do you want for distribution to a specific region?)” is displayed on the confirmation screen 600, and a “YES” button 610 and a “NO” button 620 are displayed. In step S410, a regional attribute is input (selected) in accordance with a user's operation. For example, a confirmation screen 700 shown in FIG. 7 is displayed. FIG. 7 is a diagram showing an example of presentation of the confirmation screen 700 according to this exemplary embodiment. For example, a message “Please select a distribution region (plural distribution regions can be selected) is displayed on the confirmation screen 700, and a drop-down list 710 is displayed.

In step S412, a document (an updated document may be used) is distributed to the intermediate server 200.

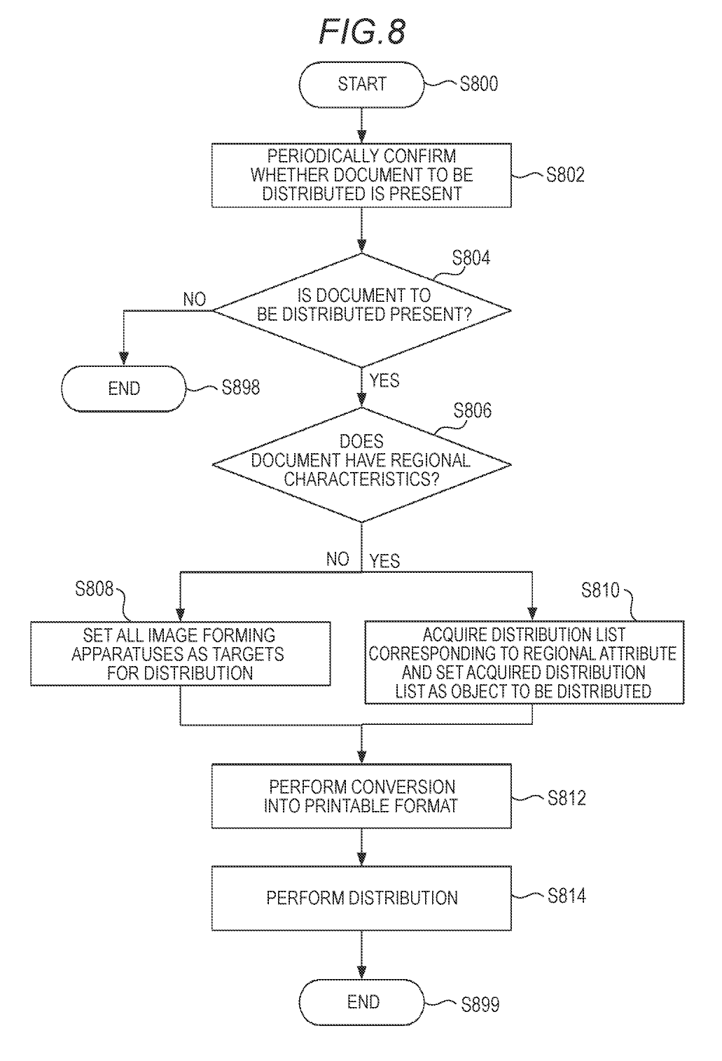

FIG. 8 is a flow chart showing an example of a process according to this exemplary embodiment. The example is an example of a process of determining a distribution destination by the intermediate server 200 and performing distribution.

In step S802, the document updating detection module 110 periodically confirms whether or not a document to be distributed is present.

In step S804, the document updating detection module 110 determines whether or not a document to be distributed is present.

In a case where a document to be distributed is present, the process proceeds to step S806, and otherwise the process is terminated (step S898).

In step S806, the document acquisition module 120 acquires a document and determines whether or not the document has regional characteristics.

In a case where the document does not have regional characteristics, the process proceeds to step S808, and otherwise the process proceeds to step S810.

In step S808, the document acquisition module 120 sets all image forming apparatuses as targets for distribution.

In step S810, the document acquisition module 120 acquires a distribution list corresponding to a regional attribute and sets the acquired distribution list as an object to be distributed.

In step S812, the document conversion module 130 performs conversion into a printable format.

In step S814, the document storage control module 140 transmits a document (an updated document may be used) to an image forming apparatus.

An example of the process of step S810 will be described below in detail.

A region selected in step S410 of the flow chart shown in the example of FIG. 4 and an image forming apparatus corresponding to the region are managed in a data structure of the image forming apparatus definition table 900 shown in the example of FIG. 9. FIG. 9 is a diagram showing an example of a data structure of the image forming apparatus definition table 900. The image forming apparatus definition table 900 includes a No. field 910, a region field 920, a distribution destination image forming apparatus field 930, and a remarks field 940. The No. field 910 stores a number (No.). The region field 920 stores a region in which an image forming apparatus is installed. The distribution destination image forming apparatus field 930 stores an image forming apparatus (for example, an IP address or the like) which is a distribution destination which is installed in the region. The remarks field 940 stores remarks. In a case where “Yokohama” is selected in step S410 of the flow chart shown in the example of FIG. 4, image forming apparatuses of Nos. 1, 2, 3, and 4 are set as distribution destinations in accordance with the image forming apparatus definition table 900 in step S810.

In the above-described example, distribution to an image forming apparatus is described with a region as a key, but a distribution destination is not limited to a region. For example, when a distribution destination is managed for each section, it is possible to perform distribution in units of sections. Specifically, an image forming apparatus definition table 1000 may be used instead of the image forming apparatus definition table 900. FIG. 10 is a diagram showing an example of a data structure of the image forming apparatus definition table 1000. The image forming apparatus definition table 1000 includes a No. field 1010, a section field 1020, a distribution destination image forming apparatus field 1030, and a remarks field 1040. The No. field 1010 stores a number (No.). The section field 1020 stores a section in which an image forming apparatus is installed. The distribution destination image forming apparatus field 1030 stores a distribution destination image forming apparatus number which is installed in the section. The section field 1040 stores a section in which an image forming apparatus is installed.

For example, in a case where a “distribution destination designation flag” attribute of a document is turned on in determining a distribution destination in the intermediate server 200, a section may be selected in step S410 of the flow chart shown in the example of FIG. 4. An image forming apparatus associated with the section is acquired from the image forming apparatus definition table 1000, and distribution to the image forming apparatus is performed. In a case where an “IT management section” is selected in the step S410 of the flow chart shown in the example of FIG. 4, image forming apparatuses of Nos. 1, 2, and 3 are set as distribution destinations.

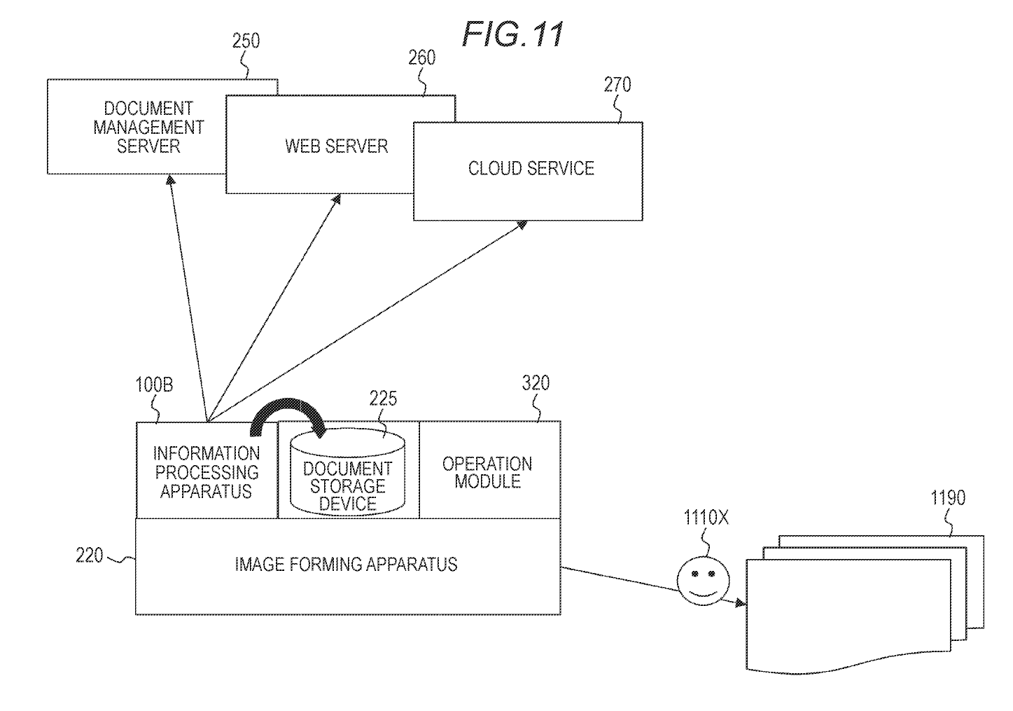

FIG. 11 is a diagram showing an example of a system configuration using this exemplary embodiment. An example of a process in a case where the information processing apparatus 100B is built into the image forming apparatus 220 is shown. In other words, the image forming apparatus 220 is configured to take a role as the intermediate server 200.

As described above, the document management server 250, the WEB server 260, the cloud service 270, and the image forming apparatus 220 are communicably connected to each other through the communication line 290.

The image forming apparatus 220 includes an information processing apparatus 100B, the document storage device 225, and the operation module 320.

The information processing apparatus 100B of the image forming apparatus 220 includes a mechanism that stores a storage location of a document which is a document acquisition destination. Specifically, the information processing apparatus 100B has a function of periodically acquiring a document based on a document acquisition destination. The image forming apparatus 220 periodically confirms an updated file based on information of an acquisition destination which is set in advance. In a case where updating is performed, replacement with an old document is performed.

In addition, the information processing apparatus 100B includes a mechanism capable of storing an acquired document in the document storage device 225. In information of a WEB and the like, a link is attached to an image, a photo, or the like, a document to be generated is often acquired from a link destination. The acquired document is converted into a printing image and is stored, thereby setting a state where the document is not required to be acquired from the link destination again.

The operation module 320 of the image forming apparatus 220 has a function of presenting a dedicated menu for a disaster. A user Ill OX operates the menu to thereby acquire a printing document 1190.

In addition, the image forming apparatus 220 may include a storage battery. For example, the image forming apparatus includes a lithium ion storage system. The image forming apparatus can print a document for coping with a disaster during the occurrence of the disaster. In addition, printing can be performed even in a case of a power failure as long as the image forming apparatus 220 is present. For example, a necessary document such as a notice, safety confirmation, a hazard map, or a wide area shelter can be printed even after a disaster.

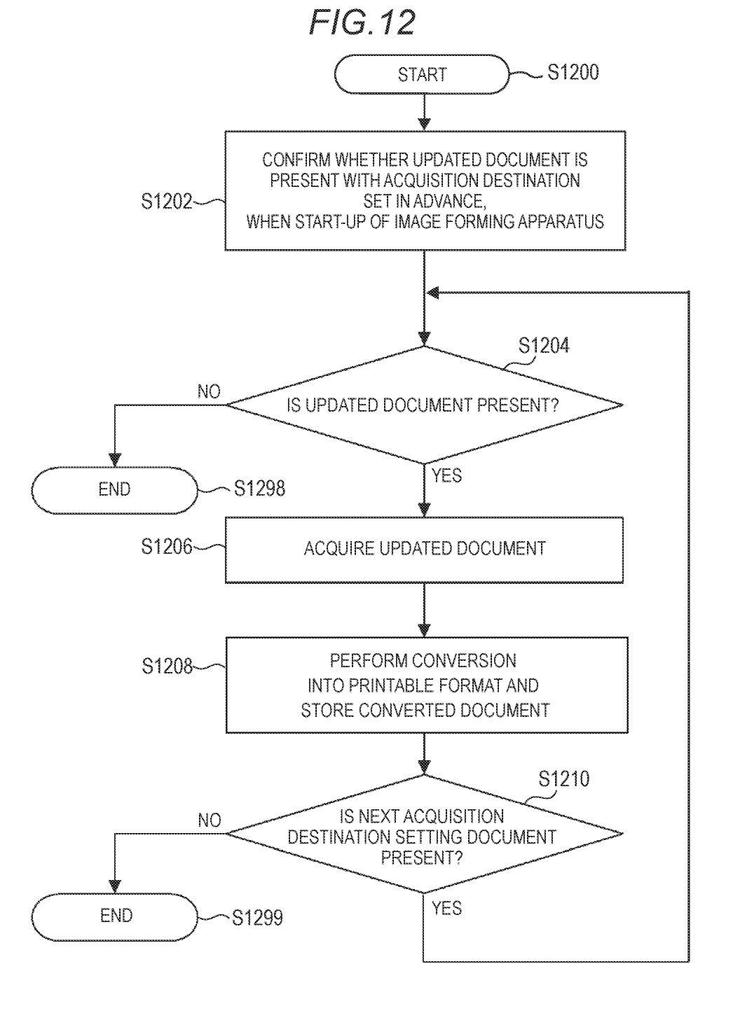

FIG. 12 is a flow chart showing an example of a process according to this exemplary embodiment. An example of a process in a case where the information processing apparatus 100B is built into the image forming apparatus 220 is shown.

In step S1202, when the start-up of the image forming apparatus 220, the document updating detection module 110 confirms, with an acquisition destination which is set in advance, whether or not an updated document is present. Meanwhile, the invention is not limited to the start-up, another timing may be adopted. For example, a case where a user's acquisition operation is performed may be adopted, or a predetermined date and time (for example, 9:00 a.m. on Monday, or the like) may be adopted.

In step S1204, the document updating detection module 110 determines whether or not an updated document is present.

In a case where an updated document is present, the process proceeds to step S1206, and otherwise the process is terminated (step S1298).

In step S1206, the document acquisition module 120 acquires an updated document.

In step S1208, the document conversion module 130 performs conversion into a printable format, and the document storage control module 140 overwrites and stores a document which is present in the image forming apparatus 220.

In step S1210, the document acquisition module 120 determines whether or not the next acquisition destination setting document is present.

In a case where the next acquisition destination setting document is present, the process returns to step S1204, and otherwise the process is terminated (step S1299).

Although the updated document is adopted in the invention, a new document may be adopted.

The process of step S1204 will be described below in detail.

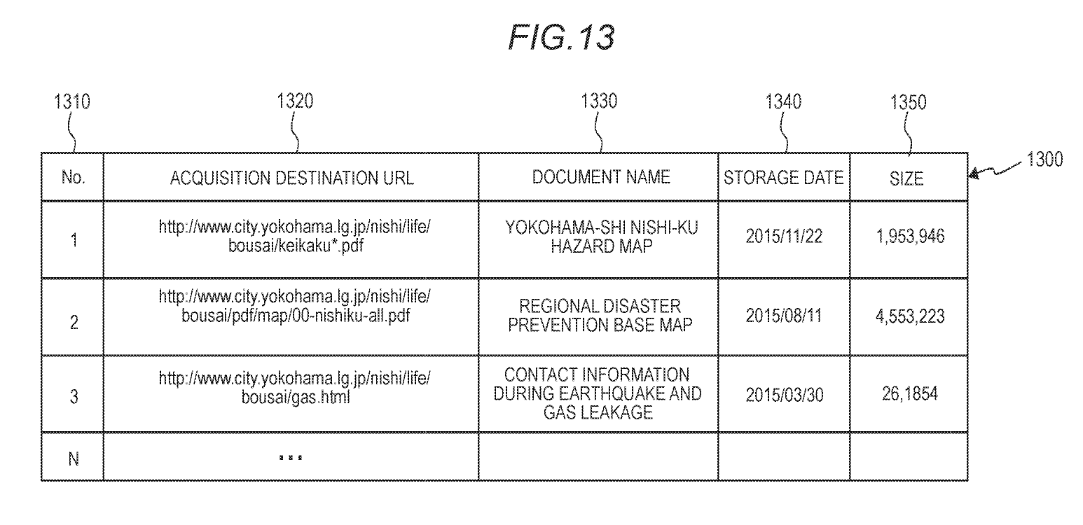

It is confirmed whether or not a document has been updated based on an acquisition destination URL. In a case where a document has been updated, the document is acquired and stored. For example, an acquisition destination document table 1300 is used. FIG. 13 is a diagram showing an example of a data structure of the acquisition destination document table 1300. The acquisition destination document table 1300 includes a No. field 1310, an acquisition destination URL field 1320, a document name field 1330, a storage date field 1340, and a size field 1350. The No. field 1310 stores a number (No.). The acquisition destination URL field 1320 stores a URL which is an acquisition destination of a document. The document name field 1330 stores a document name. The storage date field 1340 stores the date when the document is acquired. The size field 1350 stores the size of the document.

A document of the acquisition destination URL field 1320 is accessed.

In a case where a date in the storage date field 1340 of the acquisition destination document table 1300 is older than an updated date of the document, the document is set as an object to be updated.

In addition, a built-in link destination within a document such as an inline frame (iframe) may also be set as a target for the confirmation of an updated date.

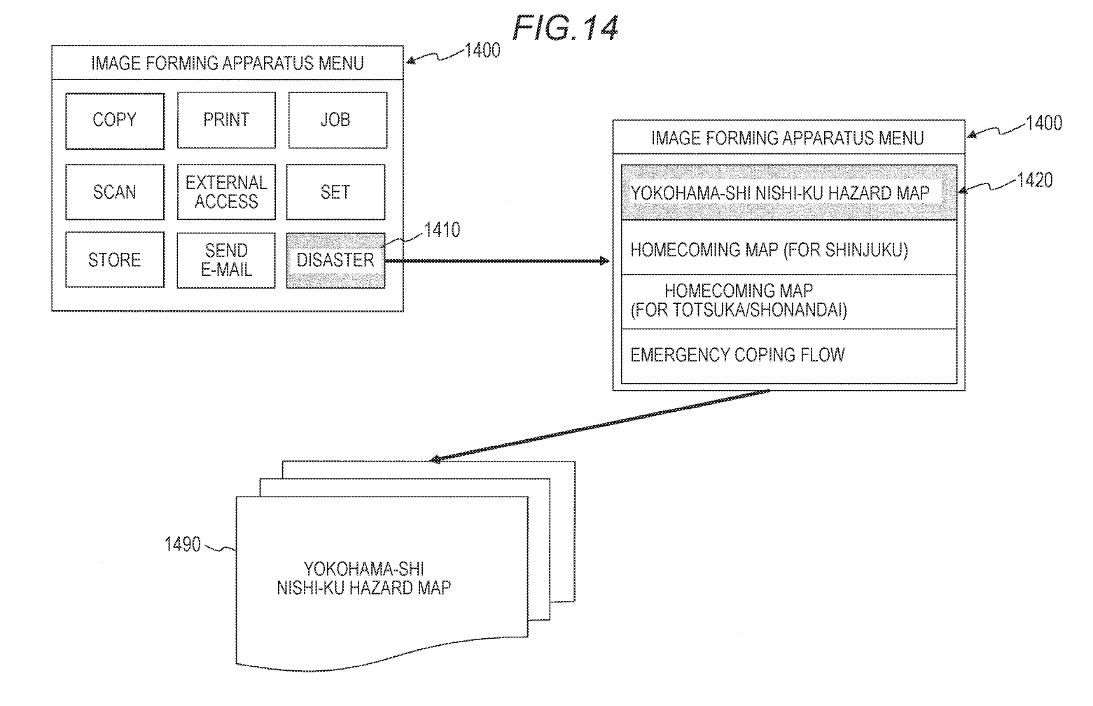

FIG. 14 is a diagram showing an example of a process according to this exemplary embodiment. An example of a process performed by the operation module 320 of the image forming apparatus 210 or the operation module 320 of the image forming apparatus 220 is shown.

An image forming apparatus menu 1400 shown in FIG. 14 is displayed on a display device such as a liquid crystal display of the image forming apparatus 210 or the like. A “copy” button, a “print” button, a “job” button, a “scan” button, an “external access” button, a “set” button, a “store” button, a “send e-mail” button, and a “disaster” button 1410 are displayed in the image forming apparatus menu 1400.

In a case where the “disaster” button 1410 is selected by a user's operation, a document menu for disaster 1420 shown in FIG. 14 is displayed. A menu capable of being confirmed during a disaster is prepared in advance. As the document menu for disaster 1420, for example, a “Yokohama-shi Nishi-ku hazard map”, a “homecoming map (for Shinjuku)”, a “homecoming map (for Totsuka/Shonandai)”, an “emergency coping flow”, and the like are displayed. These are contents of the document name field 1330 of the acquisition destination document table 1300.

In a case where the “Yokohama-shi Nishi-ku hazard map” in the document menu for disaster 1420 is selected by a user's operation, a document 1490 shown in FIG. 14 is printed out.

Even in a normal case, a document stored in the document storage device 215 or the document storage device 225 may be printed out. This is for the purpose of preparing for a disaster in advance. However, there is the possibility of the document being updated after the printing, and thus coping may be erroneously performed with an old document. Consequently, for example, the order of documents displayed within the document menu for disaster 1420 may be changed using a re-printing necessity table 1500. The re-printing necessity table 1500 is generated by the printing of a document stored in the document storage device 215 or the document storage device 225.

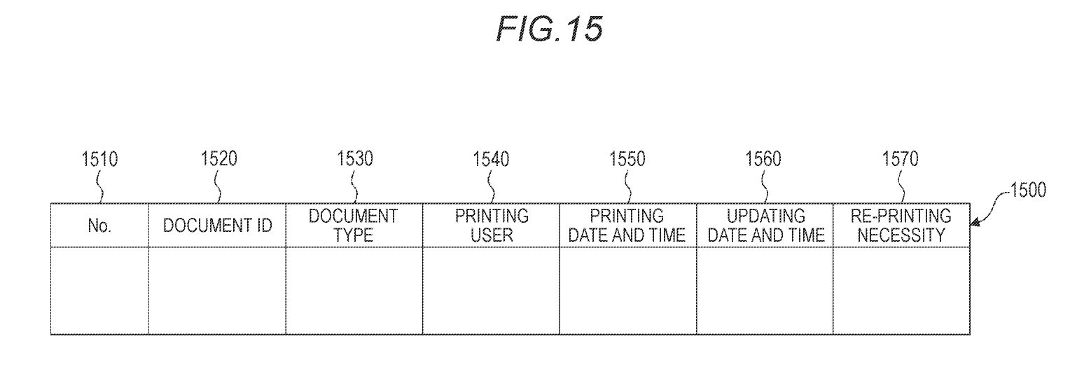

The image forming apparatus 210 or the image forming apparatus 220 stores the re-printing necessity table 1500. FIG. 15 is a diagram showing an example of a data structure of the re-printing necessity table 1500. The re-printing necessity table 1500 includes a NO. field 1510, a document ID field 1520, a document type field 1530, a printing user field 1540, a printing date and time field 1550, an updating date and time field 1560, and a re-printing necessity field 1570. The NO. field 1510 stores a number (NO.). The document ID field 1520 stores information (document identification: ID) for uniquely identifying a document in this exemplary embodiment. The document type field 1530 stores a type of document. The printing user field 1540 stores a user who presents the printing of the document. The printing date and time field 1550 stores a date and time when the document is printed. The updating date and time field 1560 stores a date and time when the document is updated (date and time when the document is stored in the document storage device 215 or the document storage device 225). The re-printing necessity field 1570 stores information indicating “necessary” and “unnecessary” of the re-printing.

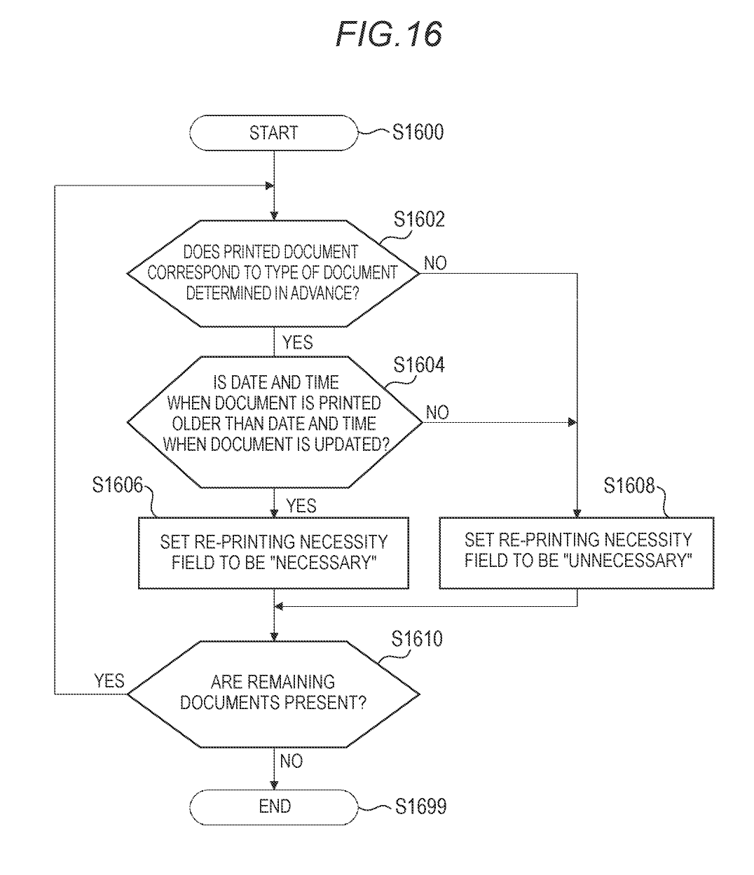

FIG. 16 is a flow chart showing an example of a process according to this exemplary embodiment. The process according to the flow chart is performed by the document storage control module 140 whenever the updating of a document is performed.

In step S1602, it is determined whether or not a printed document is a type of document which is predetermined.

In a case where the printed document is a type of document which is determined in advance, the process proceeds to step S1604, and otherwise the process proceeds to step S1608. In other words, it is determined whether or not a printing document corresponding to the type of document updated is present in the re-printing necessity table 1500. Meanwhile, in a case where a document ID is not changed in spite of the execution of updating, it may be determined whether or not a document ID of an updated document is set as a document ID of a printed document. Also in this case, when the document ID of the updated document is set as a document ID of a printed document, the process proceeds to step S1604, and otherwise the process proceeds to step S1608.

In step S1604, it is determined whether or not a date and time when the document is printed is older than a date and time when the document is updated.

In a case where the date and time when the document is printed is older than the date and time when the document is updated, the process proceeds to step S1606, and otherwise the process proceeds to step S1608.

In step S1606, the re-printing necessity field 1570 of the re-printing necessity table 1500 is set to be “necessary”. In other words, a document which is already printed indicates that updating has been performed.

In step S1608, the re-printing necessity field 1570 of the re-printing necessity table 1500 is set to be “unnecessary”.

In step S1610, it is determined whether or not remaining documents are present.

In a case where remaining documents are present, the process returns to step S1602, and otherwise the process is terminated (step S1699).

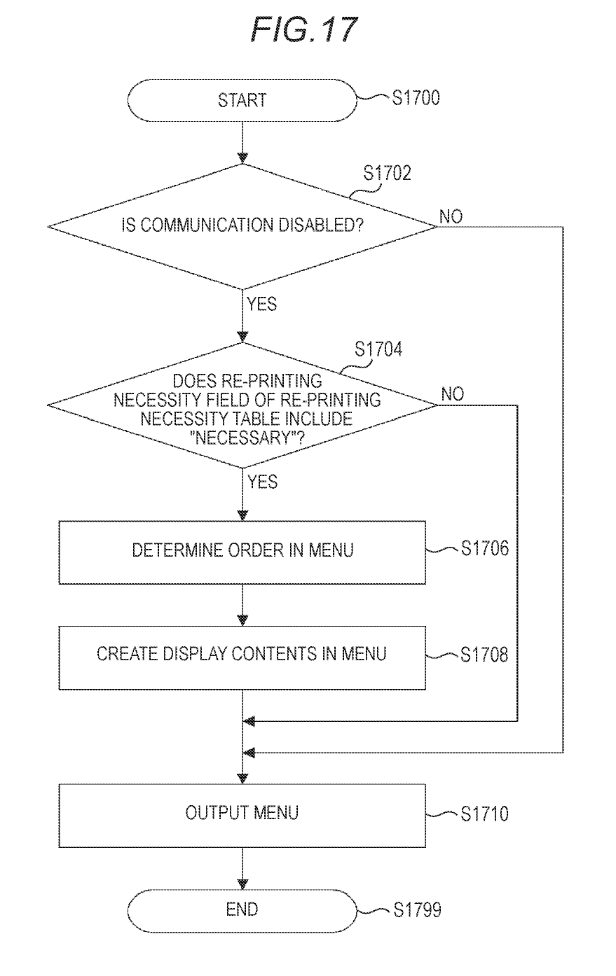

FIG. 17 is a flow chart showing an example of a process according to this exemplary embodiment.

The process according to the flow chart is performed by the image forming apparatus 210 or the image forming apparatus 220 in a case where the “disaster” button 1410 shown in the example of FIG. 14 is selected.

In step S1702, it is determined whether or not communication is disabled.

In a case where communication is disabled, the process proceeds to step S1704, and otherwise the process proceeds to step S1710. In other words, it is determined whether or not a failure has occurred in a communication line. In a case of the image forming apparatus 210, determination may be performed according to whether communication with the intermediate server 200 can be mainly performed.

In addition, step S1702 may be performed to determine whether “driving is performed by a storage battery?”. This is because there is a strong possibility that a power failure state is a state where communication cannot be performed. Further, determination of “whether communication cannot be performed?” or “whether driving is performed by a storage battery?” may be performed, or determination of “whether communication cannot be performed?” and determination of “whether driving is performed by a storage battery?” may be performed.

In step S1704, it is determined whether or not the re-printing necessity field 1570 of the re-printing necessity table 1500 includes “necessary”.

In a case where “necessary” is included, the process proceeds to step S1706, and otherwise the process proceeds to step S1710.

In step S1706, the order in the menu 1420 is determined. Specifically, a document in which the re-printing necessity field 1570 indicates “necessary” is set to a high order in the menu 1420.

In step S1708, display contents in the menu 1420 are created. Examples of the display contents include “document ΔΔΔ printed by Mr. ∘∘ is old.

A new document has to be printed.” and the like, using contents of the printing user field 1540 and the document ID field 1520 of the re-printing necessity table 1500. In step S1710, the menu 1420 is output.

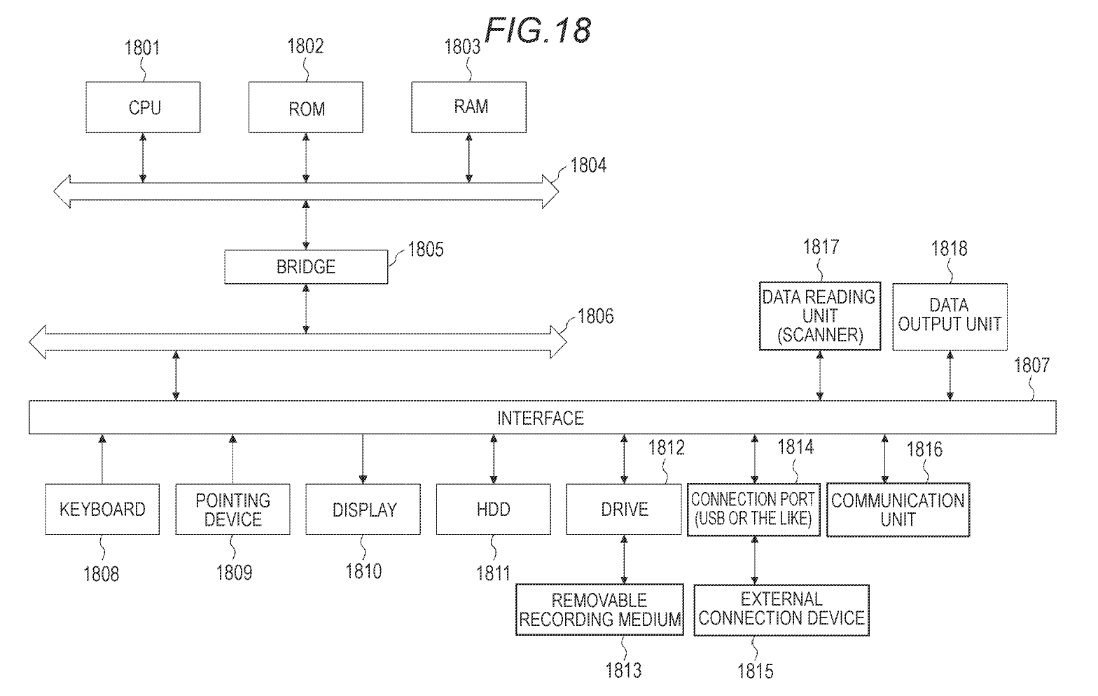

Hereinafter, reference will be made to FIG. 18 to describe an example of a hardware configuration of an information processing apparatus, an image forming apparatus, an intermediate server, or a document management server of this exemplary embodiment. The hardware configuration shown in FIG. 18 includes, for example, a personal computer (PC), and includes a data reading unit 1817, such as a scanner, and a data output unit 1818, such as a printer.

A central processing unit (CPU) 1801 is a controller that executes processing according to a computer program in which execution sequences of the various modules described in the above-described exemplary embodiment, that is, modules such as the document updating detection module 110, the document acquisition module 120, the document conversion module 130, the document storage control module 140, and the operation module 320 are described.

A read only memory (ROM) 1802 stores programs and arithmetic parameters to be used by the CPU 1801. A random access memory (RAM) 1803 stores programs to be used in the execution of the CPU 1801, parameters that appropriately change depending on the execution of the CPU, and the like. The CPU, the ROM, and the RAM are connected to each other through a host bus 1804 including a CPU bus.

The host bus 1804 is connected to an external bus 1806 such as a peripheral component interconnect/interface (PCI) through a bridge 1805.

A keyboard 1808 and a pointing device 1809, such as a mouse, are devices that are operated by an operator. A display 1810 is a liquid crystal display device, a cathode ray tube (CRT), or the like, and displays various information as text or image information.

In addition, a touch screen having both functions of the pointing device 1809 and the display 1810, or the like may be adopted.

A hard disk drive (HDD) 1811 includes a hard disk (flash memory or the like may be adopted) built therein, drives the hard disk, and records or reproduces a program executed by the CPU 1801 or information.

The HDD 1811 realizes functions as the document storage device 215 and the like. Further, the HDD stores various other pieces of data, various computer programs, and the like.

A drive 1812 reads out data or a program stored in a removable recording medium 1813 mounted therein, such as a magnetic disk, an optical disk, a magnetooptical disk, or a semiconductor memory, and supplies the data or the program to the RAM 1803 connected to the drive through the interface 1807, the external bus 1806, the bridge 1805, and the host bus 1804. Meanwhile, the removable recording medium 1813 can also be used as a data storage area.

A connection port 1814 is a port for connecting an external connection device 1815, and includes a connection unit such as a USB or an IEEE1394. The connection port 1814 is connected to the CPU 1801 and the like through the interface 1807, the external bus 1806, the bridge 1805, the host bus 1804 and the like. A communication unit 1816 is connected to a communication line and performs data communication with the outside. The data reading unit 1817 is, for example, a scanner and reads a document. The data output unit 1818 is, for example, a printer and outputs document data.

Meanwhile, the hardware configuration of the information processing apparatus, the image forming apparatus, the intermediate server, or the document management server which is shown in FIG. 18 shows one configuration example.

This exemplary embodiment is not limited to the configuration shown in FIG. 18, and a configuration capable of executing the modules described in this exemplary embodiment may be adopted. For example, some of the modules may include dedicated hardware (for example, an application specific integrated circuit (ASIC) or the like), and some of the modules may be disposed in an external system and may be connected to each other through a communication line.

Further, the system shown in FIG. 18 may include plural systems that are connected to each other through a communication line and may operate in cooperation with each other. In particular, the system may be embedded in a copier, a facsimile, a scanner, a printer, or a multifunction machine, in addition to a personal computer.

Meanwhile, the above-described program may be provided by being stored in a recording medium, or the program may be provided by a communication unit. In this case, for example, the above-described program may be treated as the invention of a “computer readable recording medium storing a program”.

The wording “computer readable recording medium storing a program” refers to a computer readable recording medium storing a program which is used for the installation, execution, and distribution of the program.

Meanwhile, examples of a recording medium include a digital versatile disc (DVD), a compact disc (CD), a Blu-ray disc (registered trademark), a magneto-optical disk (MO), a flexible disk (FD), a magnetic tape, a hard disk, a read-only memory (ROM), an electrically erasable programmable read-only memory (EEPROM (registered trademark)), a flash memory, a random access memory (RAM), a secure digital (SD) memory card, and the like.

Examples of a DVD include “a DVD-R, a DVD-RW, and a DVD-RAM”, which are standards developed by DVD Forum, and “a DVD+R and a DVD+RW”, which are standards developed by DVD+RW Alliance.

Examples of a CD include a compact disc read-only memory (CD-ROM), a compact disc recordable (CD-R), and a compact disc rewritable (CD-RW).

In addition, the entirety or a portion of the above-described program may be stored in the recording medium for distribution or storage. In addition, the above-described program may be transmitted through a transmission medium, such as a wired network, a wireless network, or a combination of these networks, or may be transferred via a carrier wave.

Examples of a wired network include a local area network (LAN), a metropolitan area network (MAN), a wide area network (WAN), the Internet, an intranet, an extranet, and the like.

Further, the above-described program may be a part of another program, or may be stored in a recording medium together with a different program. Moreover, the above-described program may be stored in segments in multiple recording media. The above-described program may be stored in any state, such as a compressed state or an encrypted state, so long as the program is restorable.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming system comprising:
an information processing apparatus; and
an image forming apparatus,
wherein the information processing apparatus comprising:
a conversion unit that converts a document into an image capable of being output by the image forming apparatus; and
a transmitting unit that transmits the image of the document obtained by the conversion through a communication line to the image forming apparatus corresponding to the document, and
wherein the image forming apparatus comprising:
a storage device provided in the image forming apparatus;
a controller that receives the image through the communication line and performs control to store the image in the storage device in a case where the communication line operates normally;
a presentation unit that presents a menu for outputting the image stored in the storage device when the communication line is disabled; and
an output unit that outputs the image stored in the storage device in accordance with operation of an operator.

2. The image forming system according to claim 1,
wherein the information processing apparatus further comprises an acquiring unit that acquires the document and an updated document in a case where the document having been acquired is updated from an external server through the communication line, and
wherein the controller replaces an image of the document prior to update with an image of the updated document.

3. An image forming apparatus comprising:
an acquiring unit that acquires an image from an external server through a communication line;
a storage device provided in the image forming apparatus;
a controller that performs control to store the image in the storage device in a case where the communication line operates normally;
a presentation unit that presents a menu for outputting the image stored in the storage device when the communication line is disabled; and
an output unit that outputs the image stored in the storage device in accordance with operation of an operator.

4. The image forming apparatus according to claim 3,
wherein in a case where the image having been acquired is updated, the acquiring unit acquires the updated image from an external server through the communication line, and
wherein the controller replaces the image stored in the storage unit with the updated image.

5. A method for controlling an image forming apparatus, the method comprising:
acquiring an image from an external server through a communication line;
performing control to store the image in a storage device provided in the image forming apparatus in a case where the communication line operates normally;
presenting a menu for outputting the image stored in the storage device when the communication line is disabled; and
outputting the image stored in the storage device in accordance with operation of an operator.

6. A non-transitory computer readable medium storing an image forming program causing a computer to function as:
an acquiring unit that acquires an image from an external server through a communication line;
a controller that performs control to store the image in a storage device provided in the image forming apparatus in a case where the communication line operates normally;
a presentation unit that presents a menu for outputting the image stored in the storage device when the communication line is disabled; and
an output unit that outputs the image stored in the storage device in accordance with operation of an operator.

7. The image forming system according to claim 1,
wherein the information processing apparatus further comprises an acquiring unit that acquires the document stored in an external server through the communication line, and
wherein the document has regional characteristics corresponding to the image forming apparatus.

8. The image forming system according to claim 2,
wherein the acquiring unit periodically confirms whether or not the document having been acquired is updated in the external server in a case where the communication line operates normally.

9. The image forming system according to claim 2,
wherein the storage device stores a date and time when the document stored in the storage device is printed and a date and time when the document is updated, and
the presentation unit presents a menu for outputting the updated document in a case where the date and time when the document is printed is older than the date and time when the document is updated.

10. The image forming system according to claim 9,
wherein the presentation unit presents a display content indicating that the document already printed is updated in a case where the date and time when the document is printed is older than the date and time when the document is updated.
